(19) United States
(12) Patent Application Publication
(10) Pub. No.: US 2015/0230442 A1
(43) Pub. Date: Aug. 20, 2015

(54) Osprei Raft

(71) Applicant: Carl Neal Prince, Margate, FL (US)

(72) Inventor: Carl Neal Prince, Margate, FL (US)

(21) Appl. No.: 14/542,434

(22) Filed: Nov. 14, 2014

(51) Int. Cl. A01K 85/00; A01K 99/00; A01K 97/00

(52) U.S. Cl. CPC A01K 85/00; A01K 97/00; A01K 99/00

(57) ABSTRACT

The Osprey Raft is the float on an Angler's Fishing Tackle that has been engineered with electronics: remote communication, a propeller system, and guidance control. It is battery operated and conveys an array of equipment; optional camera for underwater viewing, optional net, optional spare gun, hook(s) and line(s). By a line it still connects an angler's rod. The angler, by means of a remote control console, is able to move around the tackle and extend the cast. The device can be operated with a video monitor attached to the same angler's rod for underwater viewing, it can be adapted to use smart phone with a piscatorial application, providing fishing rules and regulation in whatever locale you choose to fish.

The Osprei Raft is the float on a regular fishing line that has been energized. In a dissected float, approximately 9″×5″ or 6″ diameter, —any shape or type float, gouge out a niche in one half. To neatly fit motors & accessories. Install an aluminum plate, forming a dais on the other half. This will be the foundation for mounting the hardware. This aluminum platform should be approximately 11″×5″×⅛″, and be affixed securely with plastic screws.

Allow the plate to be symmetrical-extending evenly beyond the float on either side. Drill a 1.5″ diameter hole in both ends. These holes will provide the connections at the stern of the craft to drag a fishing net; tether a fishing rod and troll hook & lines and a rope for an optional spare gun at the bow. A transmitter is implanted on the same aluminum platform via 4×¼″ studs. Complete with a power supply, a vertical steering motor, and a horizontal propeller motor, plus a contrivance of a pawl, tiller, arms, bushing and bearing. A set of pipe and bushing connect the tiller and flared pawl with teeth to catch and idle the gear of the steering motor.

On this swiveling pawl the complete propeller mechanism is mounted: a horizontal propeller motor uses a pulley to drive a vertical 4″ belt that subsequently spins the lower, propeller, shaft and the propeller, —hence motion. The rudder is attached to the bottom of the propeller housing and is weighted for stability and control.

Your float will be transformed into a hydrodynamic tug-raft. Capable of towing a phalanx of devices. The Osprei Raft is designed to perform with positive buoyancy. It does not hold up anything in the water, —this smart vessel only tugs, trolls, and prowls in a stealthy ominous silence. In the unlikely event of thermal surge the aluminum dais doubles as a heat sink, —maintaining the correct temperature, all times. The internal pieces are distributed in a scientific layout to create the perfect in-motion balance and control.

In the sequel of the most magnificent and deft cast- to achieve the maximum distance activate the forward labeled joystick on the advance remote control helm, mounted on the fishing rod. The Efloat will navigate the tackle from shoreline into the deep blue periphery—hundreds of feet beyond the conventional fling.

Angling with a tackle, dead in the water is passé.

The craft is permanently tethered to a fishing rod. A meticulously molded façade shields the propeller, keeping the lines tangle free. The Osprei Raft is engineered with an easy maneuverable cadence—it will perform flawlessly even in the most choppy swells and surfs. This digital float rules the waves.

It plies both salt and fresh water alike. Been a steward of the resources, there is nothing like reeling in from the deep. The capsule is environmentally safe. Waterproofed electronics are encapsulated in the belly of the float—there can be no spill of gasoline; no spill of oil and no pollution: it's battery operated. The deluxe model accommodates retrofitting of a: power rod, spare gun and its gimbals, satellite communication and a cordless underwater camera—capable of beaming a stream of real time video to your monitor. This brings your favorite fare into the cross hairs of the spare gun. The Osprei Raft represents a break with tradition. A bold new direction for angling. This is a novel genre. The usual tackle prohibits freedom of ocean exploration—belt the Osprei Raft emancipates thinking and expands the gamut of adventure, inciting an aura of excitement and intrigue: a denouement for pleasure and fun.

The Osprei Raft offers high technology capabilities:

It can be fully configured with GPS guided technology to interface smart devices with the launching of piscatorial applications (app). It responds intelligently to remote wireless command.

At the stem of the capsule a camera may be that installed to probe underwater targets. Anglers can spot their prey from long distances away for the speargun configuration.

The camera optimizes surveillance of remarkable images of the world below.

Crystal clear pictures can be streamed live via cable (in lieu of fishing lines) tethered to video unit terminal on the rod's console and the raft or by wireless mobile technology and your smart devices. The orientation of the speargun aligned in the appropriate relative position and its digital image/transmitted to cross hairs of the monitor on the fishing rod for selection of the aim for precise attack without parallax

The tow hitch bar forms the nexus for peripherals which balances & stabilizes the vessels thus keeping it on an even keel.

The impervious water craft can be set to a smooth continuous glide through the water or a rhythmic quick, short burst and stop cadence that adds pizazz to the lure.

The capsulized vehicle expels a powerful thrust: albeit it does not bear the weight of the naturally buoyant appendages that hover in the water, it tows them all. The Osprei Raft retrofits conventional anglers' tackle by a simple clamp-on upgrade.

A compound fishing tackle with control console creating a screen for visual effect; a joystick remote piloting for effortless maneuverability, all coalesced on the fishing rod and may be deployed from land or sea.

A staunch water craft, its form can be altered to assist in its propulsion. It spreads the gamut of the area for hunting, expand your cast and spawns the advantages of an extended arc.

Outfitted and conveying camera, net, hook and line and speargun inter alia from the shallow intertidal zone to the ocean's deepest point; inshore and off shore. Salt or fresh water. It traverses the roughest swells. Classed by function, this prototype can operate on a plurality of dispositions: mélange of sensors and timers direct its motion remotely.

The weight of the world may be too much, however, perfection can be achieved in the smallest things.

This piece of machinery will take you where no hook line nor sinker have dared to tread before.

### BRIEF DESCRIPTIONS OF DRAWINGS OF THE OSPREI RAFT

The Osprei Raft will be better understood and the objects set forth will become more apparent after a study of the following detailed description thereof. Such description make use of the annexed drawings wherein like reference numerals are carried throughout.

FIG. 1 shows a perspective view of the plan of the interior of the electro-mechanical device.

FIG. 2 shows a perspective view of the side elevation of the interior of the same electro-mechanical device.

FIG. 3 shows a perspective block diagram of the Osprei Raft

FIG. 4 shows an informal sketch of the basic device being remotely controlled

FIG. 5 shows an informal sketch of the device bearing optional camera and spear gun in addition to the same basic unit

FIG. 6 represents a digital infrastructure being controlled by smart device with piscatorial applications: featuring regional fishing regulations, weather conditions and season of inter alia.

FIG. 7 is a silhouette contouring the physiognomy of the Osprei Raft.

### DETAILED DESCRIPTION OF THE OSPREI RAFT

Reference is made herein to the attached drawings. Reference numerals are used throughout the drawings to depict various elements of the functionality of the Osprei raft.

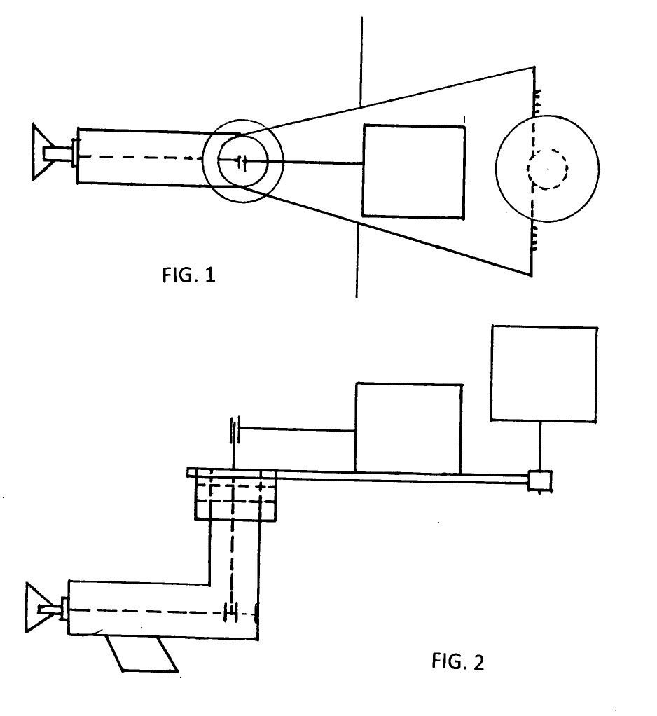

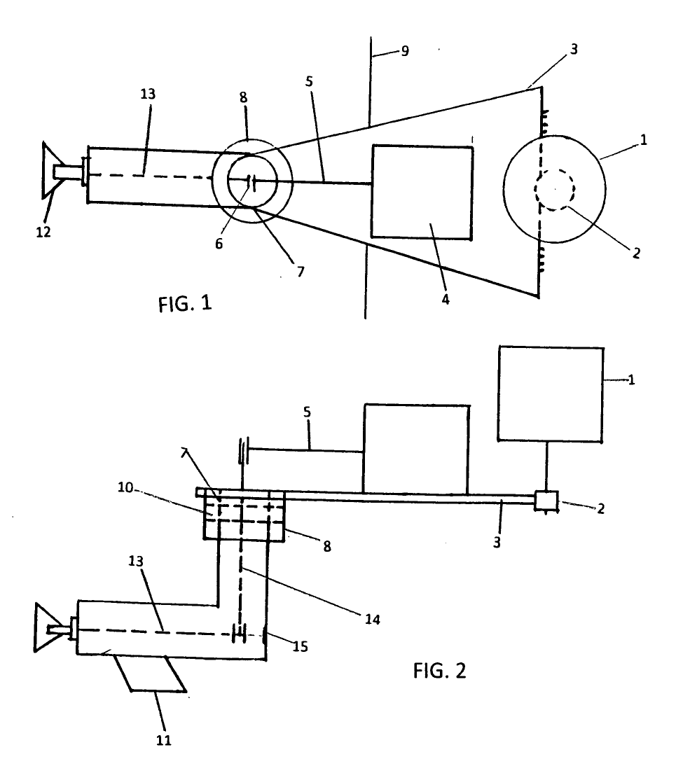

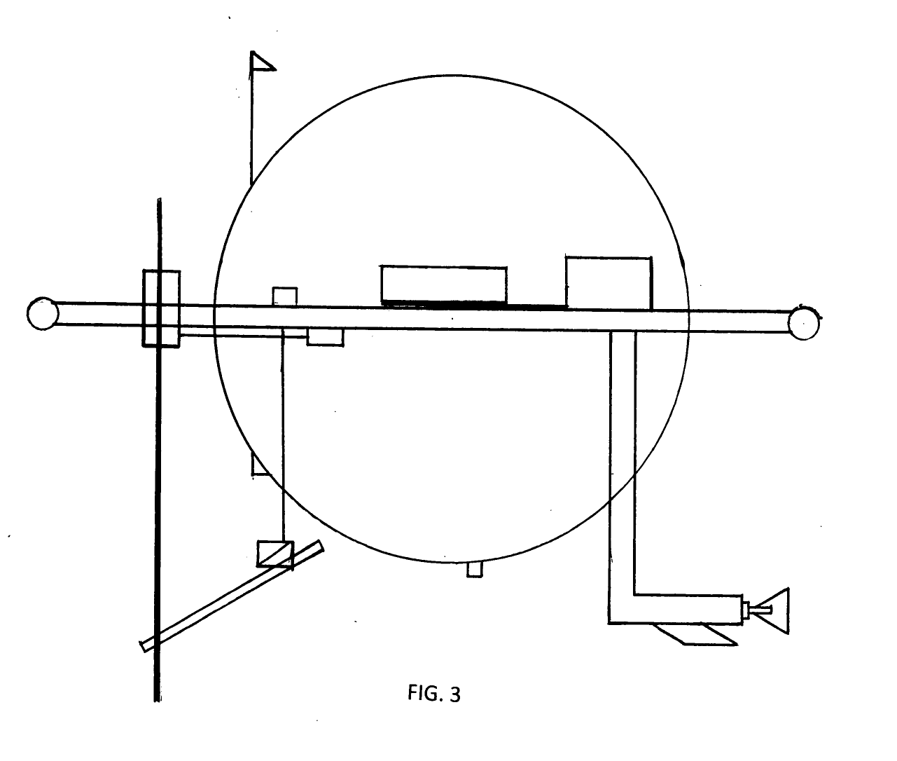

Referring now to FIG. 1 and FIG. 2: Item labeled 1 is a Steering Motor.

Item labeled 2 is a Steering Motor Gear.

Item labeled 3 is a Swivel Steering Arm, the Tiller, with Gear and Pawl.

Item labeled 4 is the Propeller Motor.

Item Labeled 5 is the Propeller Motor Shaft.

Item labeled 6 is the Propeller Motor Pulley.

Item labeled 7 is the Swivel Steering Housing.

Item labeled 8 is the Fixed Steering Housing.

Item labeled 9 are Hair Springs.

Item labeled 10 is a Bearing.

Item labeled 11 is the Rudder.

Item labeled 12 is the Propeller.

Item labeled 13 is the Propeller Shaft.

Item Labeled 14 is the Drive Belt.

Item Labeled 15 is the Structural Support.

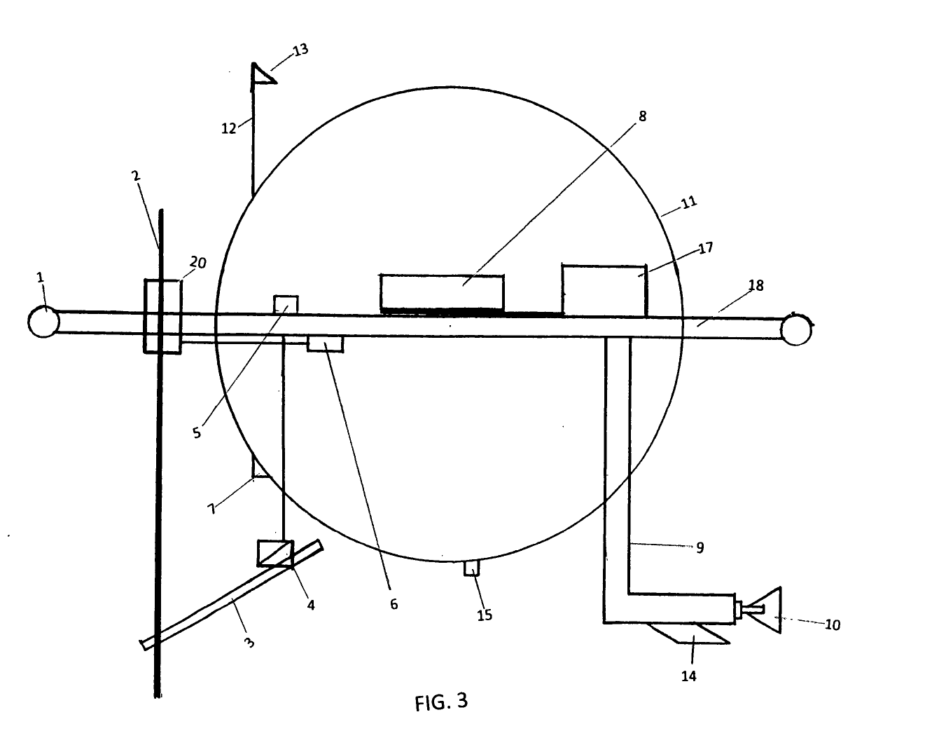

Referring now to FIG. 3: Item Labeled 1 is a Swivel Ring Connector. Item labeled 2 is a movable rod—focuses the Spear Gun. Item labeled 3 is the Spear Gun. Item labeled 4 is the Spear Gun Trigger Mechanism. Item labeled 5 is the Trigger Solenoid. Item labeled 6 is the Gun Target Motor. Item labeled 7 is the Underwater Camera. Item labeled 8 is Electronics. Item labeled 9 is the Propeller Housing. Item labeled 10 is the Propeller. Item labeled 11 is the Float. Item labeled 12 is the Antenna. Item labeled 13 is a Pennant. Item labeled 14 is the Rudder. Item labeled 15 is the Cleat. Item labeled 17 is the Propeller-Steering Mechanism. Item labeled 18 is the Heat Sink Dias (platform).

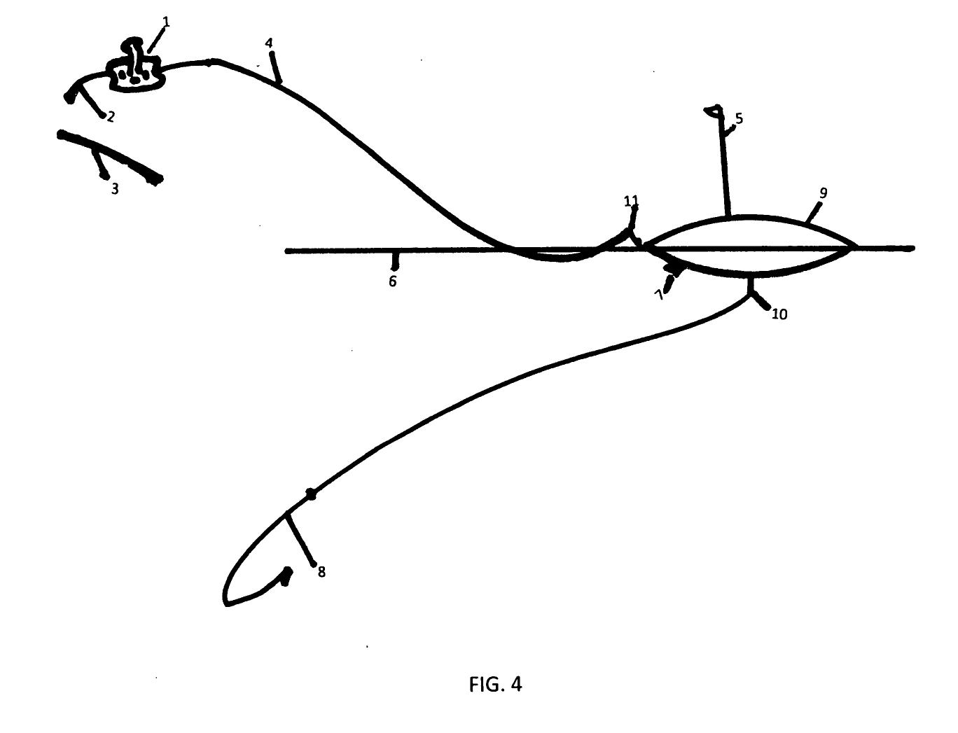

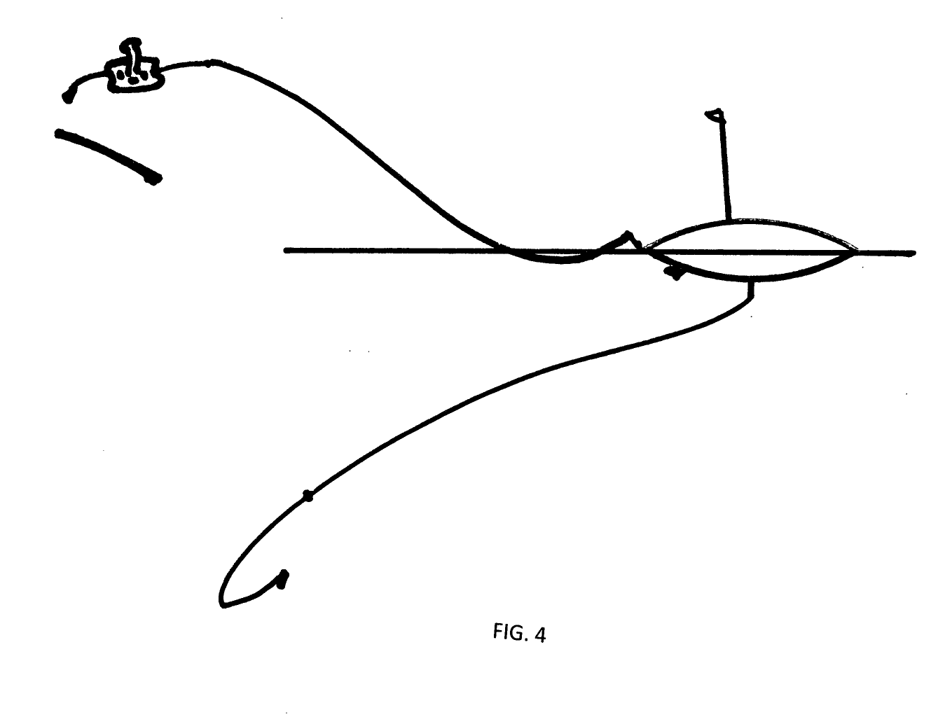

Referring now to FIG. 4: Item labeled 1 is the remote control console. Item labeled 2 is the handle of the fish rod. Item labeled 3 is the ground, the bank of the water. Item labeled 4 is the line still tethering a remote control Osprei Raft to the angler's rod. Item labeled 5 is the antenna bearing a conspicuous pennant, standing out so as to be clearly visible. Item labeled 6 is the water level. Item labeled 7 is the outboard propeller rudder mechanism. Item labeled 8 is the hook, line and sinker. Item labeled 9 is the float. Item labeled 10 is the cleat. Item labeled 11 is the tow hitch.

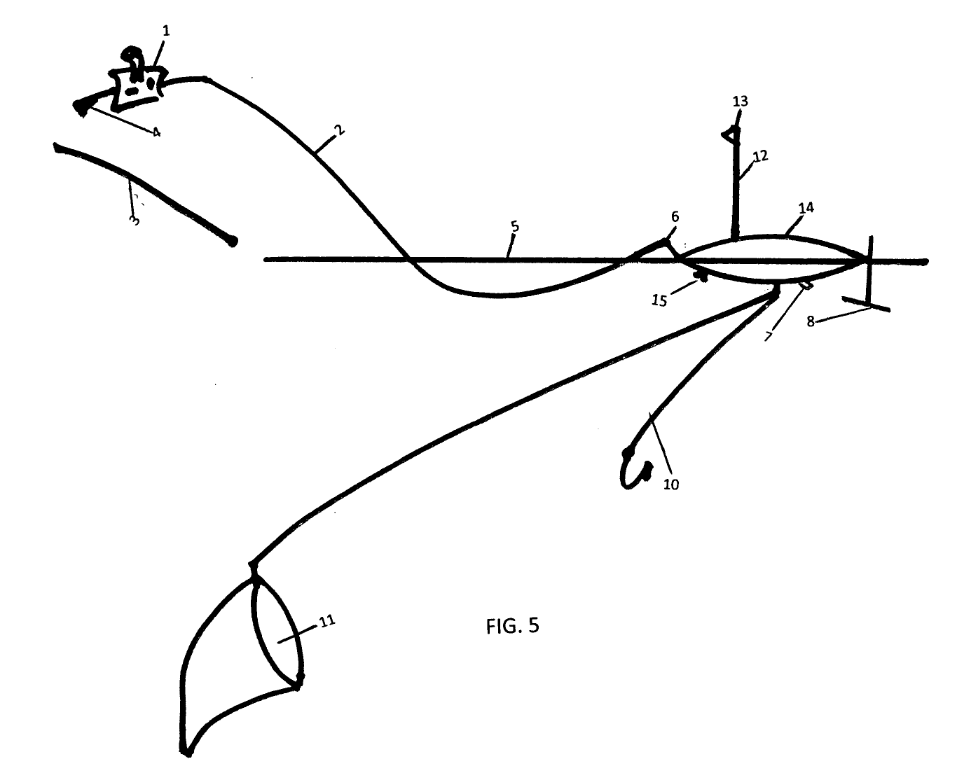

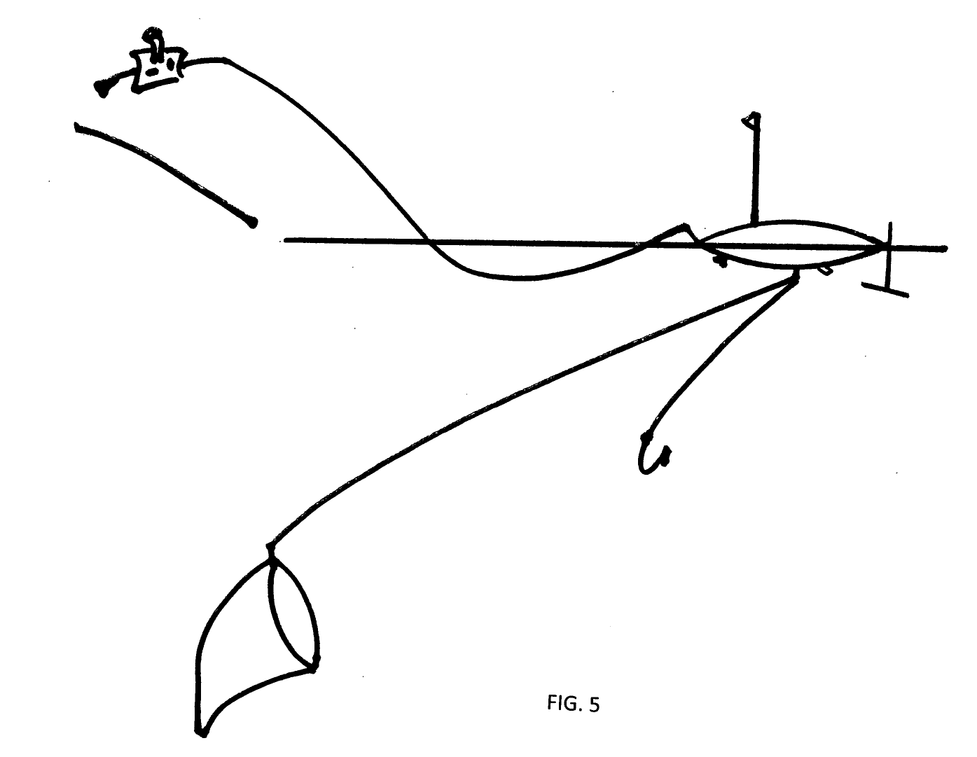

Referring now to FIG. 5: Item labeled 1 is the remote control console. Item labeled 2 is the line. Item labeled 3 is the ground. Item labeled 4 is the rod. Item labeled 5 is the water level Item labeled 6 is the tow hitch connection. Item labeled 7 is the camera. Item labeled 8 is the spare gun. Item labeled 10 is the hook, line and sinker. Item labeled 11 is the net. Item labeled 12 is the antenna. Item labeled 13 is the pennant. Item labeled 14 is the float. Item labeled 15 is the outboard propeller rudder mechanism.

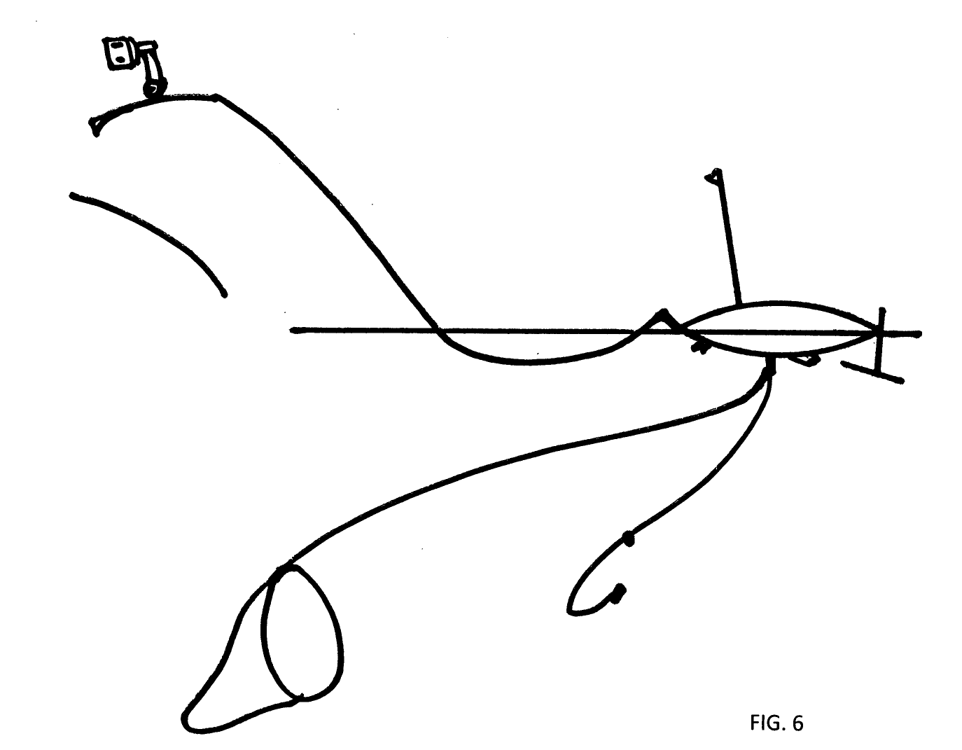

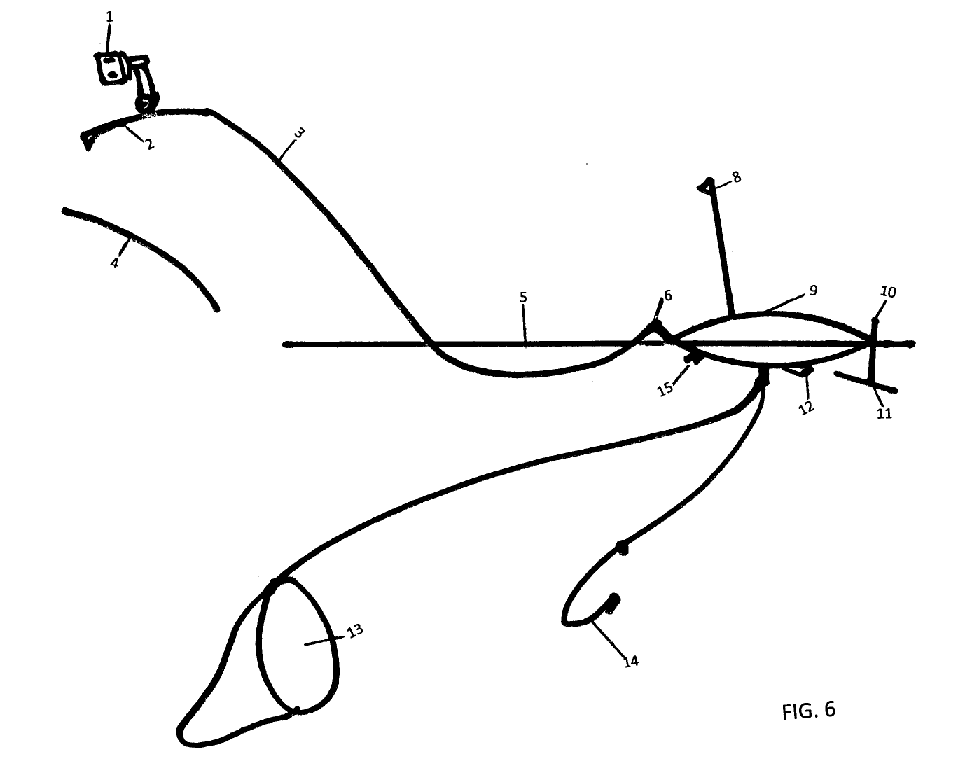

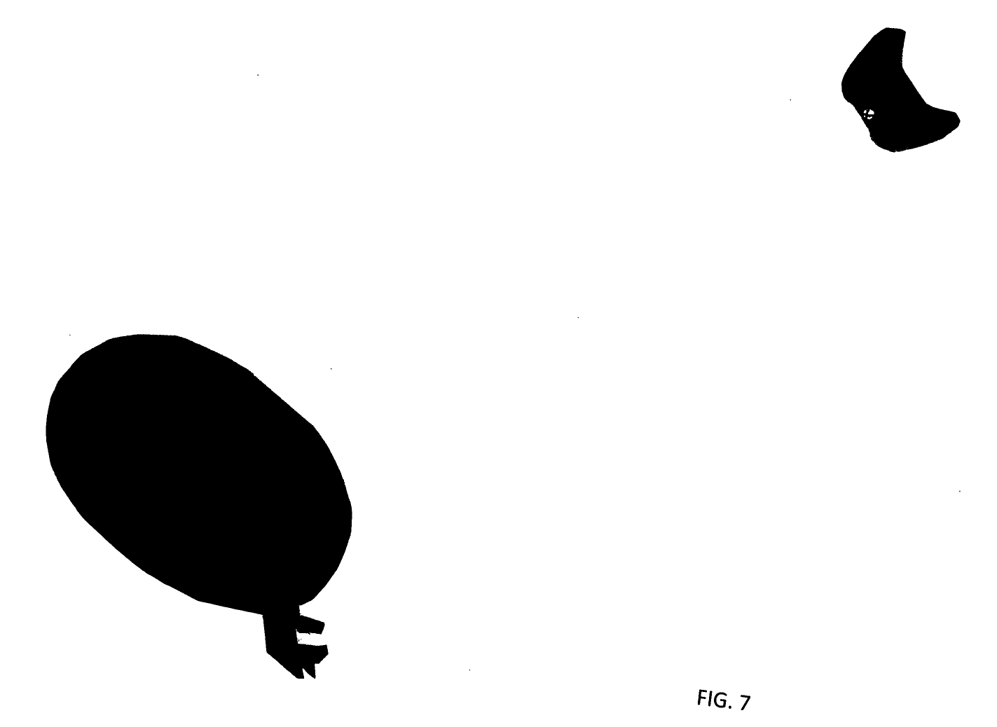

Referring now to FIG. 6: Item labeled 1 is the smart phone. Item labeled 2 is the rod. Item labeled 3 is the line. Item labeled 4 is the ground. Item labeled 5 is the water level. Item 1 labeled 6 is the tow hitch. Item labeled 8 is the pennant. Item labeled 9 is the float. Items 10 and 11 are the spare gun & its contrivance. Item labeled 12 is the camera. Item labeled 13 is the net. Item labeled 14 is the hook, line and sinker. Item labeled 15 is the outboard propeller rudder mechanism

1. A. Motorized Fishing Tackle, Comprising:
a. a buoyant component encapsulating electronics, communication and mechanical hardware,
b. remote link between the helm of the said fishing tackle and the said buoyant component of the said fishing tackle, and
c. having means for attachment of plurality of devices,
whereby said fishing tackle will be self-propelled in the water.
